(19) United States
(12) Patent Application Publication
(10) Pub. No.: US 2008/0284881 A1
(43) Pub. Date: Nov. 20, 2008

(54) METHOD AND SYSTEM FOR VIDEO MOTION BLUR REDUCTION

(76) Inventors: Ike Ikizyan, Newport Coast, CA (US); Brian Schoner, Fremont, CA (US)

Correspondence Address: MCANDREWS HELD & MALLOY, LTD, 500 WEST MADISON STREET, SUITE 3400, CHICAGO, IL, 60661, US

(21) Appl. No.: 11/869,364

(22) Filed: Oct. 9, 2007

Related U.S. Application Data
(60) Provisional application No. 60/938,675, filed on May 17, 2007.

(51) Int. Cl. H04N 5/16

(52) U.S. Cl. 348/258; 348/E05.069

(57) ABSTRACT

A video frame may be divided into plurality of sub-frames to reduce motion blur in sample-and-hold display. The plurality of sub-frames may preserve, in their totality, the luminance and coloring of the original input frames. An input frame that is Y′CrCb encoded may be converted to R′G′B′ to enable luminance conversion onto the plurality of sub-frame while preserving the coloring information of said input frame. The first of said plurality of sub-frames may comprise energy and/or luminance encoded into the original frame with remaining energy and/or luminance encoded into remaining sub-frames. Determining luminance encoding of said plurality of sub-frames may be performed dynamically or may be determined based on programmable look-up tables. Frame conversion may compensate for nonlinearity in sample-and-hold displays that may be utilized to display the output sub-frames, wherein said nonlinearity may be caused by the gamma characteristics of said displays.

### CROSS-REFERENCE TO RELATED APPLICATIONS/INCORPORATION BY REFERENCE

This patent application makes reference to, claims priority to and claims benefit from U.S. Provisional Application Ser. No. 60/938,675 filed on May 17, 2007.

The above stated application is hereby incorporated herein by reference in its entirety.

### FEDERALLY SPONSORED RESEARCH OR DEVELOPMENT

[Not Applicable]

### MICROFICHE/COPYRIGHT REFERENCE

[Not Applicable].

### FIELD OF THE INVENTION

Certain embodiments of the invention relate to video applications. More specifically, certain embodiments of the invention relate to a method and system for video motion blur reduction.

### BACKGROUND OF THE INVENTION

In video systems, an image is projected in a display terminal such as televisions and/or PC monitors. Most video broadcasts, nowadays, utilize digital video applications that enable broadcasting video images in the form of bit streams that comprise information regarding characteristics of the image to be displayed. There are various types of display terminals. Cathode Ray Tube (CRT) displays utilize impulsive technology, wherein electronic beam may be utilized to excite pixels on a screen with the electronic beam getting deflected and/or modulated to enable scanning the screen to create video images on said screen. More recently, Liquid Crystal Display (LCD) and Plasma displays have gained popularity.

Motion blur is an artifact caused when an object moving in a series of images move, thereby resulting in streaks or smears. Motion blur is most prominent on LCD monitors or LCD TVs. LCD monitors or LCD TVs utilize a sample and hold technology in which frames are frozen on the screen for a duration that is related to frequency of video broadcast. This is also referred to as a zero-order hold. For example, with video broadcast at f Hz, a video frame is frozen on the screen for 1/F^{th} of a second and then the display may abruptly be shifted to the next frame. The sample and hold technology that causes the streaks or smears is visually unpleasing.

Further limitations and disadvantages of conventional and traditional approaches will become apparent to one of skill in the art, through comparison of such systems with some aspects of the present invention as set forth in the remainder of the present application with reference to the drawings.

### BRIEF SUMMARY OF THE INVENTION

A system and/or method is provided for video motion blur reduction, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1A illustrates emission characteristics of LCD display vs. CRT display, in connection with an embodiment of the invention.

FIG. 1B illustrates a comparison of emission characteristics between LCD display and CRT display, in accordance with an embodiment of the invention.

FIG. 2A is a diagram illustrating luminance levels of f Hz progressive frames when energy is divided into 2 sub-frames, in accordance with an embodiment of the invention.

FIG. 2B illustrates the gamma characteristics of a non-linear display, which may be utilized in accordance with an embodiment of the invention.

FIG. 2C illustrates a one-to-two frame division that compensates for gamma characteristics of a non-linear display, which may be utilized in accordance with an embodiment of the invention.

FIG. 3 is a block diagram illustrating an exemplary system that may enable video motion blur reduction, which may be utilized in accordance with an embodiment of the invention.

FIG. 4A is a block diagram illustrating an exemplary system that utilizes lookup-up tables (LUTs) to derive color components for sub-frames based on color components of an original frame, which may be utilized in accordance with an embodiment of the invention.

FIG. 4B is a block diagram illustrating an exemplary dual LUTs system that enable reprogrammability and selectivity, which may be utilized in accordance with an embodiment of the invention. Referring to FIG. 4B, there is shown.

FIG. 5 is an exemplary flow diagram illustrating video motion blur reduction in system that converts f Hz frames to 2f Hz sub-frames, in accordance with an embodiment of the invention.

### DETAILED DESCRIPTION OF THE INVENTION

Certain embodiments of the invention may be found in a method and system for video motion blur reduction. Motion blur may occur in sample-and-hold type displays. To reduce motion blur, an input frame may be divided into a plurality of sub-frames wherein the plurality of sub-frames may preserve, in their totality, the luminance and color of the original input frames. The input frame may initially be Y′CrCb encoded. Consequently, the input frame may be converted from Y′CrCb to R′G′B′ to enable luminance conversion onto the plurality of sub-frames while preserving the coloring information of said input frame. A first of the plurality of sub-frames may comprise most of the energy and/or luminance encoded into the original frame with remaining energy and/or luminance encoded into remaining sub-frames. Determining luminance encoding of the plurality of sub-frames may be performed dynamically. Alternatively, luminance encoding information may be programmed into look-up tables that may be utilized to perform said luminance conversion between original frame and plurality of sub-frames. Frame conversion may also compensate for nonlinearity in sample-and-hold displays that may be utilized to display the output sub-frames, wherein said nonlinearity may be caused by the gamma characteristics of said displays.

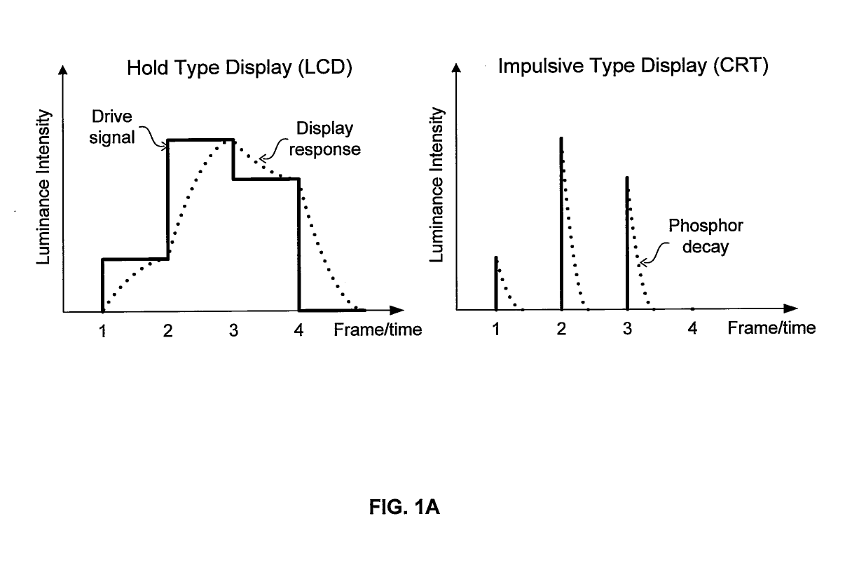

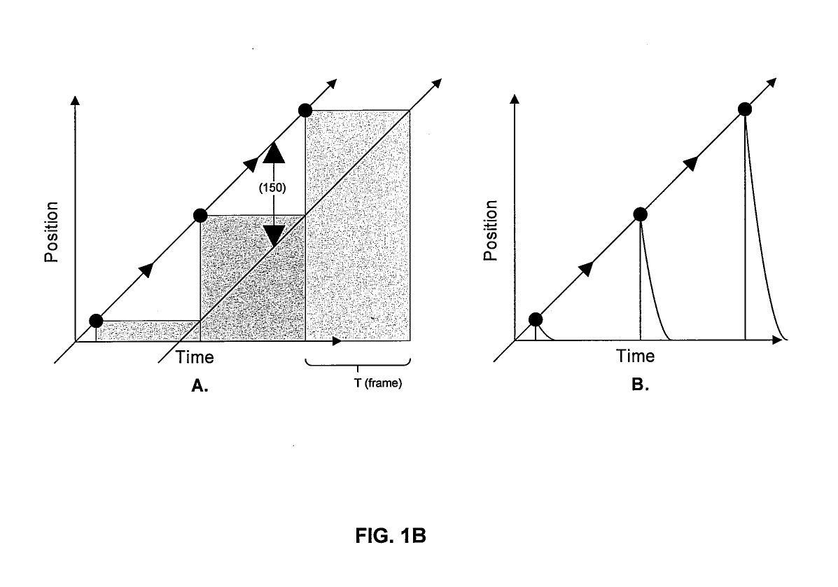

FIG. 1A illustrates emission characteristics of LCD vs. CRT, in connection with an embodiment of the invention. Referring to FIG. 1, there is shown two charts demonstrating characteristics of LCD (Liquid Crystal Display) and CRT (Cathode Ray Tube) displays when displaying a video frame.

Some video displays suffer from motion blur. “Motion blur” causes moving objects to appear soft, fuzzy, or streaky. Motion blur on displays is analogous to blur on photographs due to a slow shutter speed. Impulsive displays, such as Cathode Ray Tubes (CRT), work by exciting phosphors which emit light but do so for only short impulsive duration which quickly decays back to darkness. On the other hand, sample-and-hold displays, such as Liquid Crystal Display (LCD), essentially hold the current image until a new image is ready to display, a characteristic described as a zero-order hold characteristic. Motion blur is particularly objectionable on displays with sample-and-hold pixels (LCD) rather than displays with impulsive pixels (CRT).

FIG. 1B illustrates a comparison of emission characteristics between LCD display and CRT display, in accordance with an embodiment of the invention. Due to the zero-order hold characteristic of an LCD display, motion blur occurs. The arrow 150 may indicate the amount of “smearing” that may take place. One can think of this as a continuous version of the case for ghosting made in the case of frame repetition. An obvious solution is to blink the backlight at the refresh rate. This makes the LCD behave more impulsive in nature. However, this requires a new backlight design.

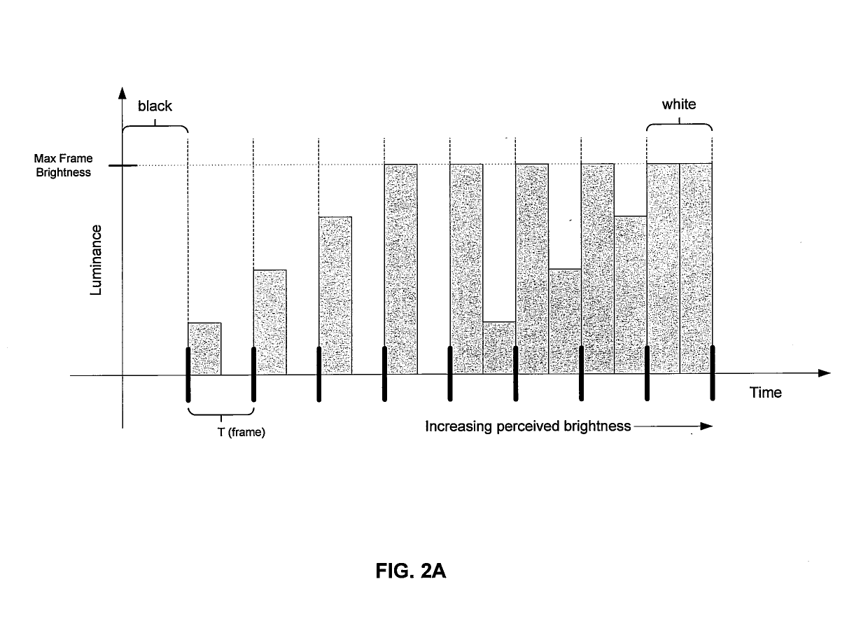

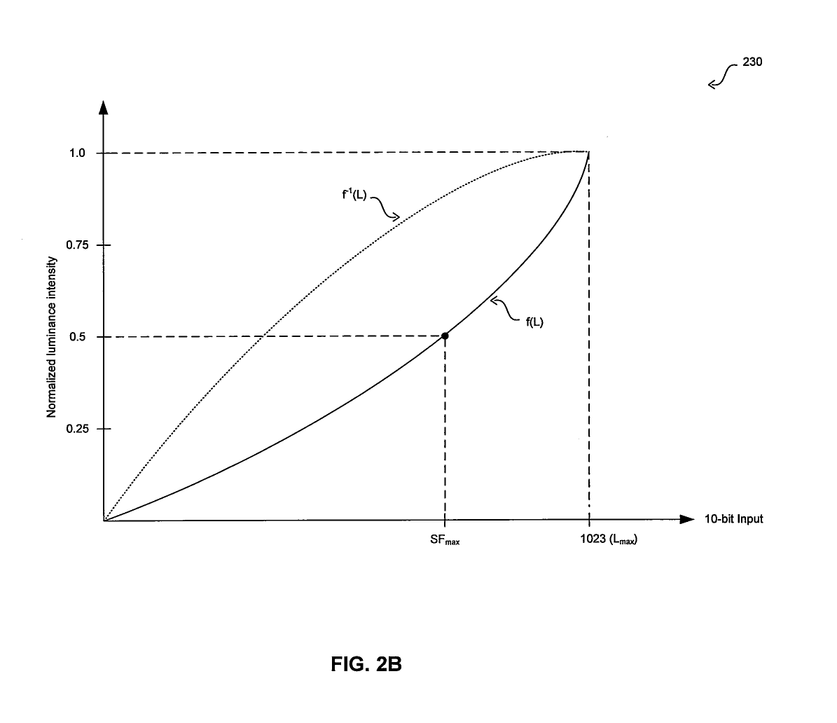

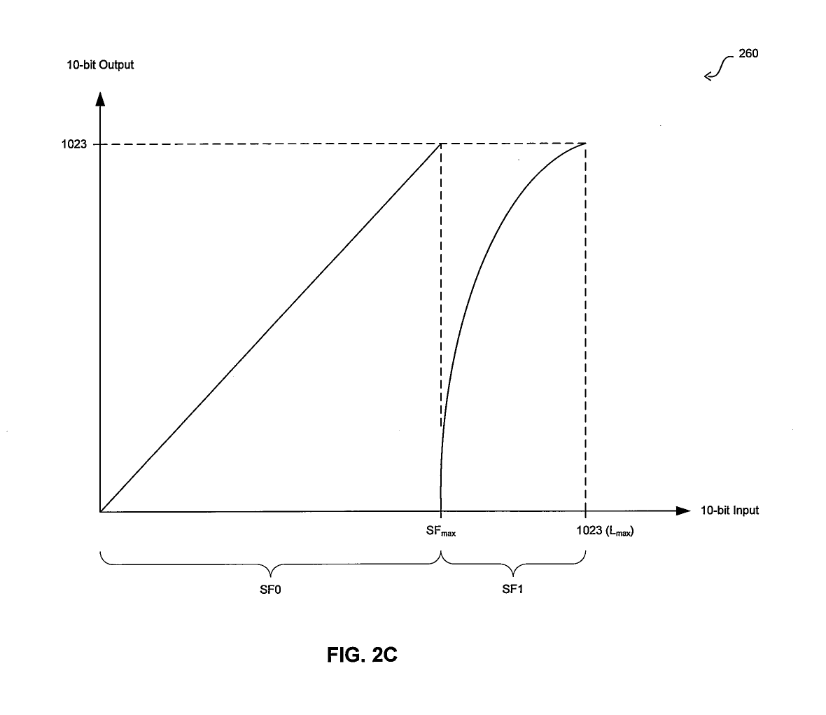

FIG. 2 is a diagram illustrating luminance levels of f Hz progressive frames when energy is divided into 2 sub-frames, in accordance with an embodiment of the invention. Referring to FIG. 2, there is shown a time-luminance 2-dimensional plane.

The luminance axis reflects image luminance, which is a representation of brightness in an image. Generally speaking, luminance connotes degree of whiteness/blackness in the image, and consequently energy carried in corresponding video frames. Due to characteristics of the video transmission, the luminance of a frame and/or sub-frame may be limited by a max value that pixels in the target display terminal may not exceed, and which is shown as “max frame brightness.” A frame or sub-frame comprising “max frame brightness” may represent a white pixel. On the other hand, a frame or sub-frame that comprises “0” luminance may represent a black pixel.

The time axis is divided into equal time units, T, wherein T represents the period of original frames, and is the reciprocal of f, the frequency of the input video stream from which the original frames were extracted. For example, where the original input stream operates at f=60 Hz, T is equal to 1/f, or 1/60 seconds.

According to an embodiment of the invention, each f Hz progressive frame may be divided into two 2f Hz sub-frames. For example, where an input video stream, that may comprises original frames, has a frequency of 60 Hz, an output video stream may be generated, comprising sub-frames, may have a frequency of 120 Hz. The two sub-frames may temporally “average” by the human visual system to represent the original f Hz frame. For black pixels, each f Hz pixel may be represented by two 2f Hz black pixels. For white pixels, each f Hz pixel may be represented by two 2f Hz white pixels. A 50% grey f Hz pixel may be achieved with one 2f Hz white pixel and one 2f Hz black pixel. In between these three limits, one pixel may be represented with grey and black sub-pixels while another pixel may be represented with grey and white sub-pixels. In other words, the sub-frames may be computed on a pixel-by-pixel basis wherein each f Hz frame may be represented by 2 sub-frames one of which is either white or black pixel, while the second may comprise a “grey” pixel with varying luminance. Each f Hz “dark” pixel may be represented by one 2f Hz grey pixel and one 2f Hz black pixel, while each “bright” pixel may be represented by one 2f Hz fully white pixel, and one 2f Hz bright pixel. Varying the degree of grayness of the “grey” 2f Hz pixel changes in brightness and/or darkness in the “bright” and/or “dark” f Hz pixels.

Digital image processing systems may utilize Y′CrCb. In a Y′CrCb system, the Cr and Cb are the color, or chroma, component of a digital image. The Y′ is the brightness, or luma, component of a digital image. Digital image processing system may utilize luma values that correspond to perceptual lightness (CIE lightness). The relationship between lightness (L), a perceptual quantity, and luminance (Y), a physical quantity, may be approximately exponential and indicated as follows:

Y=L^{2.5}

L=Y^{0.4}

In accordance with an exemplary embodiment of the invention, two new frames that “add up,” in terms of luminance, gamma, and color, to the original frame may be created. Dividing Y′CrCb triplets that represent original frames into sub-frames may not be desirable. Most LCD panels operate in the RGB colorspace so it is desirable to generate the sub-frames in the same colorspace. While Y′CrCb may be a convenient representation for most image processing, it may be inadequate for the invention because many Y′CrCb combinations are physically unrepresentable. Unrepresentable combinations are called “out of gamut.” For example, a Y′CrCb triplet in a system that utilizes 8-bit encoding may be converted from: [127, 0, 127] to two new frames: [255, 0, 127] and [0, 0, 127]. In this example, the two new frames may “average” the original frame. However, the triplet [255, 0, 127] may be out of gamut. Y=255 represents maximum white (in an 8-bit system) and has no room for color. On the other hand, with the second triplet, [0, 0, 127], Y=0 represents minimum black, and also has no room for color. Therefore, because Cb=127 represents maximum blue, it may not be combined with Y=255 (white) or Y=0 (black).

In one embodiment of the invention, the input video frame may be transformed from Y′CrCb lightness (L) to RGB luminance (Y) to facilitate division of original frame into plurality of sub-frames. The conversion process may comprise the following exemplary steps: (1) convert original Y′CrCb lightness (L) to RGB luminance (Y); (2) place as much energy as possible into the first sub-frame; (3) any remaining energy may be placed into a second sub-frame; and (4) optionally convert RGB luminance to Y′CrCb lightness in new frames. The amount of energy that may be placed into the first frame may be limited by frame “max frame brightness” value in the system and/or the display used. For example, an input Y′CrCb frame may be first converted into an original RGB frame, wherein the Y′CrCb lightness Lᵢₙ of the original frame may be converted to RGB luminance Yᵢₙ, wherein Yᵢₙ=(Lᵢₙ)^{2.5}. The derivation of the RGB color component may be performed based on conversion formula that may be system-dependant. Two sub-frames, SF0 and SF1, may be generated, wherein both sub-frames may have the same RGB color components; however, the two sub-frames may be assigned different RGB luminance values: Y_{SF0} and Y_{SF1}, wherein Yᵢₙ=[Y_{SF0}+Y_{SF1}]/2.

In an exemplary system that may utilize 8-bit video encoding, the maximum value for lightness in each Y′CrCb frame is 255. Therefore, the first sub-frame may not be assigned RGB luminance value such that its Y′CrCb lightness equivalent exceeds 255. Consequently, the RGB luminance values of the sub-frames, Y_{SF0} and Y_{SF1}, may be assigned such that their Y′CrCb lightness equivalents: L_{SF0} and L_{SF1} are such that (Lᵢₙ)^{2.5}=[(L_{SF0})^{2.5}+(L_{SF1})^{2.5}]/2, wherein most of the original frame lightness may be encoded into the first sub-frame up to the largest RGB luminance value that may be equivalent to the maximum Y′CrCb lightness value. Accordingly, for example, with an input Y′CrCb encoded with Y′ of 200, the two sub-frames SF0 and SF1 may be encoded with Y′ values of 255 and 97 because (200)2.5=˜[(255)^{2.5}+(97)^{2.5}]/2.

In an alternative embodiment of the invention, look-up-tables (LUTs) may be utilized to perform RGB conversion between original frame and generated frames. The conversion process, via LUTs may comprise the following exemplary steps: (1) convert the original Y′CrCb (lightness) to R′G′B′ (lightness); (2) use LUTs to calculate 2 new R′G′B′ values from each original; and (3) optionally convert from R′G′B′ back to Y′CrCb. In this regard, the conversion from lightness to luminance with the original frame may not be necessary. The look-up tables (LUT) may be utilized to effectively perform the lightness/luminance conversions. For example, an input Y′CrCb frame may be first converted into its R′G′B′ frame, wherein the Y′CrCb lightness of the original frame may be converted to R′G′B′ lightness. The derivation of the R′G′B′ color components may be performed based on conversion formula that may be system-dependant. Two sub-frames, SF0 and SF1, may be generated, wherein both sub-frames may have the same R′G′B′ color components. The two sub-frames may be assigned different R′G′B′ lightness values. The R′G′B′ lightness values that may be assigned into the sub-frames may be pre-determined and/or pre-programmed into the LUTs. The R′G′B′ encoding for the sub-frames are programmed such that most of the energy of the original frame is encoded into the first sub-frame, with any remaining energy beyond the maximum value that may be put into the first frame may be encoded into the second frame. Optionally, the R′G′B′ sub-frames may then be converted to their Y′CrCb equivalent based on the conversion formula in the system. The R′G′B′ frame-to-subframe conversions encoded into the LUTs may also compensate for gamma characteristics of a display where the resultant video stream may be directed, substantially as described in FIG. 2B and FIG. 2C.

FIG. 2B illustrates the gamma characteristics of a non-linear display, which may be utilized in accordance with an embodiment of the invention. Referring to FIG. 2B, there is shown an x-y chart 230 representing the display brightness intensity as function of input luminance encoded values, which may be utilized in digital video encoding systems.

In operations, the y-axis represents f(L), the normalized luminance intensity ranging from 0 to 1.0, wherein normalized luminance intensity value of 1.0 represents maximum available pixel brightness in a non-linear display and the normalized luminance intensity value of 0.0 representing normalized luminance intensity of a black pixel in the display. The normalized luminance intensity values represented in the y-axis correspond to input luminance encoded values represented in the x-axis, wherein the input luminance encoded values range from 0 to Lₘₐₓ, wherein Lₘₐₓ represents the maximum allowed luminance encoded value. For example, in a system that utilizes 10-bit luminance encoding, luminance encoded values may range from 0 to 1023.

The chart 230 represents the gamma nonlinearity characteristic of a non-linear display wherein normalized luminance intensity increases in non-linear fashion; rather, increases in input values may cause exponential increases in the corresponding normalized luminance intensity. Consequently, increasing input luminance encoded values by a factor of 2 may not cause doubling the normalized luminance intensity. Therefore, due to the nonlinearity of the gamma non-linear display, the input luminance encoded value corresponding to the 0.5 normalized luminance intensity may not necessarily correspond to the input luminance encode value representing the halfway point value. For example, in a system utilizing 10-bit luminance encoding, the 0.5 normalized luminance intensity may exceed the halfway luminance encoded value of 512. The input luminance encode value corresponding to the 0.5 normalized luminance intensity may be designated SFₘₐₓ, wherein doubling the normalized luminance intensity of luminance input values exceeding SFₘₐₓ would yield intensity values exceeding 1.0, the maximum available pixel brightness the display.

In accordance with an exemplary embodiment of the invention, an input frame may be divided into two output sub-frames, wherein the brightness of the two output sub-frames averages out to the brightness of the input frame with most of the brightness may be encoded into the first sub-frame and only remaining brightness that may not be encoded into the first sub-frames may be encoded into the second sub-frame. Accordingly, the luminance encoded values assigned to the sub-frames must average, in their totality, to the same normalized luminance intensity as the input frame. Therefore, the assignment of the luminance encoded values to the sub-frames may differ between situations where the luminance encoded values of the input frame maybe less than, or equal to SFₘₐₓ, and situations where the luminance encoded value of the input frame exceeds SFₘₐₓ. For example, where the input luminance encoded value (input frame) is L, the luminance encoded values of the sub-frames SF0 and SF1, L_{SF0} and L_{SF1}, must be assigned such that:

f(L)=[f(L_{SF0})+f(L_{SF1})]/2

Where f(L) is the normalized luminance intensity of the of the input frame, and f(L_{SF0}) and f(L_{SF1}) are the normalized luminance intensities of the sub-frames SF0 and SF1, respectively.

In instances where L<=SFₘₐₓ, the first sub-frame may be encoded such that f(L_{SF0})=[2f(L)−f(0)], while the second sub-frame may be encoded as a black frame with normalized luminance intensity 0.0, or f(L_{SF1})=f(0). In displays that do not suffer from “leakage,” wherein the panel may “leak” some light even when setting luminance encoded value to 0 to generate black pixels, f(0) may simply be reduced to 0. Accordingly, the equation my be simplified as follows:

f(L_{SF0})=2f(L), and f(L_{SF1})=0

Assuming f(L)=L^{a} where a is a constant (e.g. a=2.5) and solving for L_{SF0} yields:

L_{SF0}=f⁻¹(2f(L))=(2*L^{a})^{1/a}=2^{1/a}*L=c*L where c=2^{1/a}

Thus, L_{SF0} is linear as shown in chart 260.

In instances where L>SFₘₐₓ, the previous equations may not be utilized because, by definition, the SFₘₐₓ represent the maximum value enabling doubling of corresponding normalized luminance intensity without exceeding the maximum normalized luminance intensity allowed in the display. Consequently, in instances where L values exceed SFₘₐₓ, (L>SFₘₐₓ), the first sub-frame may be encoded to the maximum normalized luminance intensity, or in other words f(L_{SF0})=f(Lₘₐₓ), with the remaining necessary intensity encoded into the second sub-frame, where

f(L_{SF1})=2f(L)−f(Lₘₐₓ)

In a system that utilizes 10-bit encoding for input frame and output sub-frames, L_{SF0} may be set simply to Lₘₐₓ, or simply to 1023.

FIG. 2C illustrates a one-to-two frame division that compensates for gamma characteristics of a non-linear display, which may be utilized in accordance with an embodiment of the invention. Referring to FIG. 2C, there is shown an x-y chart 260 demonstrating relationship between luminance encoded values for input frame and luminance encoded values for two output sub-frames.

In operation, the luminance encoded values of the output sub-frame may be calculated substantially as described in FIG. 2B. However, because it may be desirable to encode as much energy into the first sub-frame as possible, for input values in the range of 0 to SFₘₐₓ, it may suffice to encode the first sub-frame to represent a linear display response. Therefore, for input luminance encoded values ranging between 0 to SFₘₐₓ, the first sub-frame, SF0, may be assigned luminance encoded values ranging between 0 to Lₘₐₓ₍ₒᵤₜₚᵤₜ₎, along a linear response while the second sub-frame, SF1, may simply be assigned luminance encoded value 0. For input values exceeding SFₘₐₓ, the first sub-frame, SF0, may not be encoded beyond luminance encoded value corresponding to the maximum normalized luminance intensity. Therefore, the first sub-frame, SF0, may be encoded to luminance encoded value Lₘₐₓ₍ₒᵤₜₚᵤₜ₎. The second sub-frame, SF1, however, may be set to luminance encoded value that may be necessary to enable the combined intensity of both sub-frames to average out to the normalized luminance intensity of the input frame. In other words, for a non-linear display with gamma characteristics substantially as described in FIG. 2B, the second sub-frame may be assigned value as follows:

L_{SF1}=f⁻¹(2f(L)−f(Lₘₐₓ))

Therefore, the graph representing luminance encoded values assigned to SF1 for input luminance encoded values exceeding SFₘₐₓ may be characterized by the inverse of the exponential chart representing f(L).

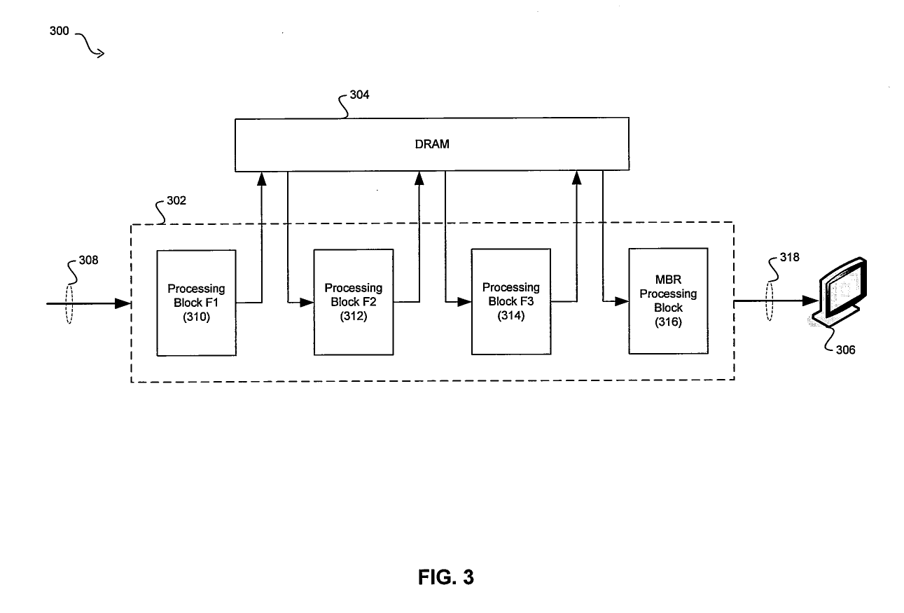

FIG. 3 is a block diagram illustrating an exemplary system that may enable video motion blur reduction, which may be utilized in accordance with an embodiment of the invention. Referring to FIG. 3, there is shown a video processor 302, a Dynamic Random Access Memory (DRAM) 304, a video display 306, an input video stream 308, a processing block F1 310, a processing block F2 312, a processing block F3 314, a Motion Blur Reduction (MBR) processing block 316, and an output video stream 318.

The video processor 302 may comprise the processing block F1 310, the processing block F2 312, the processing block F3 314, the MBR processing block 316, and suitable logic, circuitry and/or code that may enable video processing operations. The invention may not be limited to a specific processor, but may comprise for example, a general purpose processor, a specialized processor or any combination of suitable hardware, firmware, software and/or code, which may be enabled to provide motion blur reduction in accordance with the various embodiments of the invention.

Each of the processing block F1 310, the processing block F2 312, and the processing block F3 314 may comprise suitable logic, circuitry and/or code that may enable performing operations that may be necessary during video processing. For example, may enable performing such video operations as scaling, deinterlacing, sharpening, and/or noise reduction. The MBR processing block 316 may comprise suitable logic, circuitry and/or code that may enable performing motion blur reduction operations during video processing.

The DRAM 304 may comprise suitable logic, circuitry and/or code that may enable non-permanent storage and fetch of data and/or code used by the video processor 302 during video processing and/or motion blur reduction operations. While FIG. 3 shows the DRAM 304 situated external to the video processor 302, this may not exclude having the DRAM 304 integrated internal within the video processor 302.

The input video stream 308 may comprise a sequence of original frames that may be displayed via the video display 306 after getting processed via the video processor 302. The output video stream 318 may comprise a stream of processed frames that may be displayed via the video display 306. The video display 306 may comprise suitable logic, circuitry and/or code that may enable displaying the output video stream 318. For example, in systems that may utilize f Hz video input, the video display 306 may comprise a sample-and-hold display, for instance, LCD displays, that may enable displaying video frames inputted into the video display 306 at 2f Hz.

In operations, input video stream 308 may be received by the video processor system 302. The video processor 302 may utilize the DRAM 304 for storing and/or fetching data utilized during processing of input video stream 308. The processing blocks 310, 312, and/or 314 may be utilized during video processing of input video stream 308 in the video processor 302. The processing blocks 310, 312, and/or 314 may enable performing such operations as scaling, deinterlacing, sharpening, and/or noise reduction. While performing these operations in the processing blocks 310, 312, and/or 314, data may be stored into, and fetched from the DRAM 304. Storing and/or fetching data may enable retention of processed information while control may switch between the different processing blocks. Additionally, storing and/or fetching data from the DRAM 304 may enable introduction of delay that may compensate for processing delays in other processing blocks and/or subsystems in the video processor 302.

The MBR processing block 316 may operate substantially similar to the processing blocks 310, 312, and/or 314, and may also store into, and fetch data from the DRAM 304. The MBR processing block 316 may enable performing motion blur reduction operations, substantially as described in FIG. 2A, FIG. 2B, and FIG. 2C.

In an alternate embodiment of the invention, the luminance encoded values that may be assigned to output sub-frames may be determined, and pre-programmed into look-up tables (LUTs). Accordingly, MBR processing block 316 may comprise such LUTs wherein luminance conversions that may be performed during motion blur reduction operation may be achieved by simply “looking-up” luminance encoded values that may be assigned to output sub-frames based on luminance encoded values of input frames.

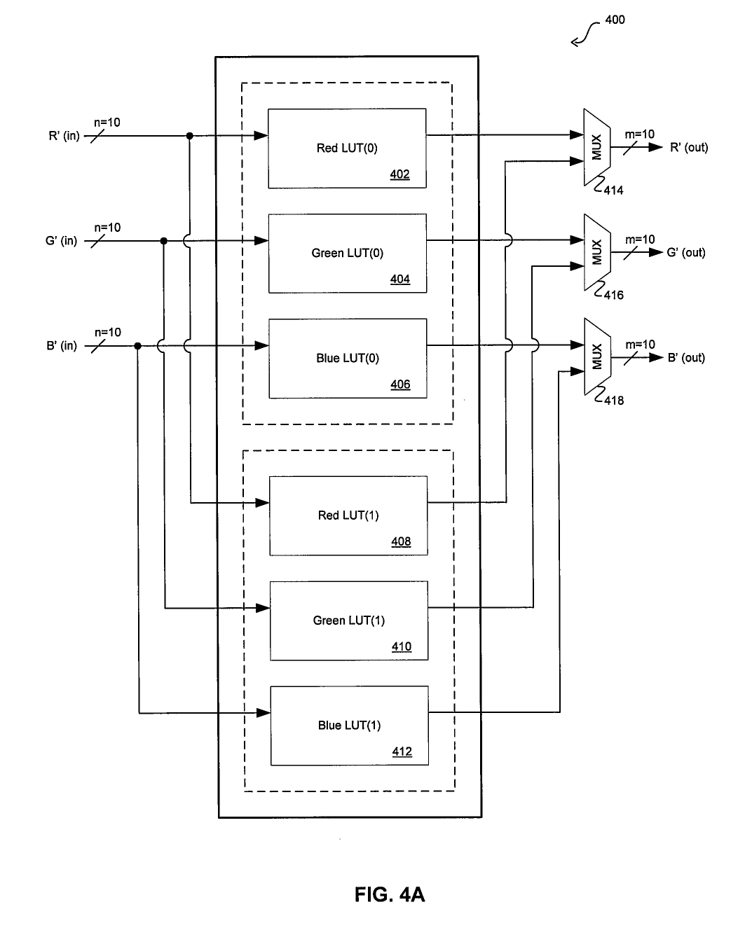

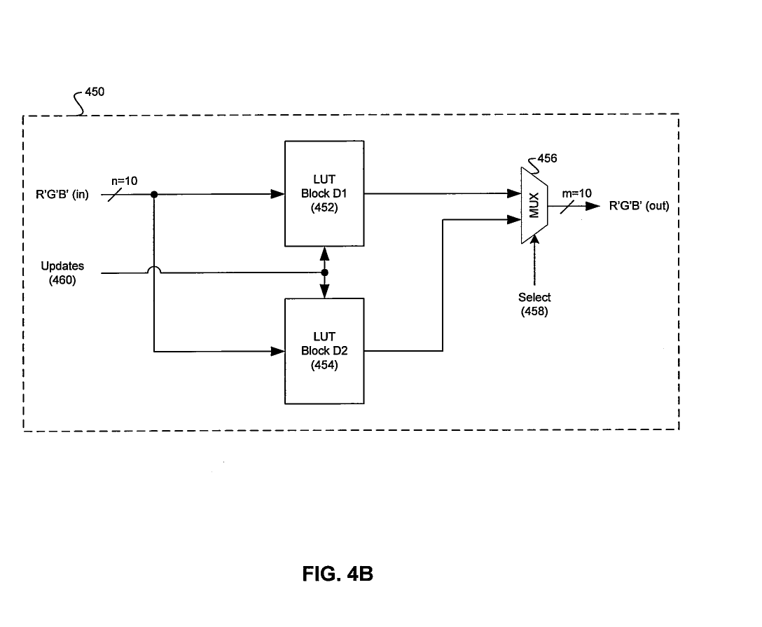

FIG. 4A is a block diagram illustrating an exemplary system that utilizes lookup-up tables (LUTs) to derive color components for sub-frames based on color components of an original frame, which may be utilized in accordance with an embodiment of the invention. Referring to FIG. 4A, there is shown a LUT-based system 400, a red LUT(0) 402, a green LUT(0) 404, a blue LUT(0) 406, a red LUT(1) 408, a green LUT(1) 410, a blue LUT(1) 412, a red multiplexer (MUX) 414, a green multiplexer (MUX) 416, and a blue multiplexer (MUX) 418.

In operation, the LUTs 402, 404, 406, 408, 410, and 412 may enable determining the luminance encoded values for the red, green, and blue components of the output sub-frames based on the luminance encoded values of the red, green, and blue components of the input frame. For example, for each input luminance encoded value there may be two luminance encoded values that may be encoded into the two sub-frames SF0 and SF1. The output luminance encoded values may initially be calculated substantially as described in FIG. 2B and FIG. 2C. The output luminance encoded values may then be stored into LUTs corresponding to both sub-frames, and for each color component. In other words, for the luminance encoded value of the red component R′(in), of the input frame, the output luminance encoded values of the red components of sub-frames SF0 and SF1 may be stored into red LUT(0) 402 and red LUT(1) 408, respectively. For the luminance encoded value of the green component, G′(in), of the input frame, the output luminance encoded values of the green components of sub-frames SF0 and SF1 may be stored into green LUT(0) 404 and green LUT(1) 410, respectively. The luminance encoded value of the blue component, B′(in), of the input frame, the output luminance encoded values of the blue components of sub-frames SF0 and SF1 may be stored into blue LUT(0) 406 and blue LUT(1) 412, respectively.

The duration of the plurality of the sub-frames may be equal to the duration of the input frame. Consequently, for each input frame, the plurality of the sub-frames may be displayed sequentially. Therefore, the RGB components of the sub-frames SF0 and SF1 may be read sequentially to enable displaying SF0 and SF1 in sequential manner. The MUXs 414, 416, and 418 may enable reading the RGB components of the sub-frames SF0 and SF1 sequentially. For example, to display SF0, red MUX 414 may enable setting R′(out) to the output from red LUT(0) 402, green MUX 416 may enable setting G′(out) to the output from green LUT(0) 404, and blue MUX 418 may enable setting B′(out) to the output from blue LUT(0) 406. Similarly, to display SF1, red MUX 414 may enable setting R′(out) to the output from red LUT(1) 408, green MUX 416 may enable setting G′(out) to the output from green LUT(1) 410, and blue MUX 418 may enable setting B′(out) to the output from blue LUT(1) 412.

FIG. 4B is a block diagram illustrating an exemplary dual LUTs system that enables reprogrammability and selectivity, which may be utilized in accordance with an embodiment of the invention. Referring to FIG. 4B, there is shown dual LUTs system 450, LUT block D1 452, LUT block D2 454, output multiplexer (MUX) 456, select signal 458, and updates input 460.

The LUT block D1 452 and the LUT block D2 454 may each be comprised substantially similar to the LUT-based system 400. The MUX 456 may enable selection of an output from a plurality of inputs based on control signal “Select” input 458. The “updates” input 460 may comprise information, data, and/or code that maybe enable reprogramming LUTs in the LUT block D1 452 and/or the LUT block D2 454.

In operation, the dual LUTs system 450 may enable video processing operation that may comprise utilizing motion blur reduction. The MUX 456 may enable selecting between the outputs of the LUT block D1 452 and the LUT block D2 454 based on the “select” input 458. The LUT block D1 452 and the LUT block D2 454 may enable performing various video conversions based on stored information and/or data in their LUTs. For example, the LUT block D1 452d may be programmed to enable performing motion blur reduction substantially as described in FIG. 4A, while the LUT block D2 454 may be programmed to pass forward the received video frames unaltered, which may be achieved simply by encoding each of the plurality of the sub-frames identical to the original frame. Accordingly, the LUT block D1 452 and the LUT block D2 454 may enable demonstrating the improvement that may occur because of the invention wherein pixels in a part the display 306 may be fed from the LUT block D1 452, and pixels in the remaining part of the display 306 may be fed from the LUT block D2 454.

Other operations may be enabled utilizing the dual LUTs system 450. For example, the LUT block D1 452 and the LUT block D2 454 may also enable updating a video processing with new R′G′B′ conversion information during use of the dual LUTs system 450. The “select” input 458 may enable utilizing the LUT block D1 452, which may comprise current R′G′B′ conversion information, while LUT block D2 454 may be updated with new R′G′B′ conversion information fed from the “updates” input 460. Subsequently, the dual LUTs system 450 may switch to using the new R′G′B′ information by selecting the output of LUT block D2 454 via MUX 456 while the LUT block D1 452 may also be updated with the new R′G′B′ information.

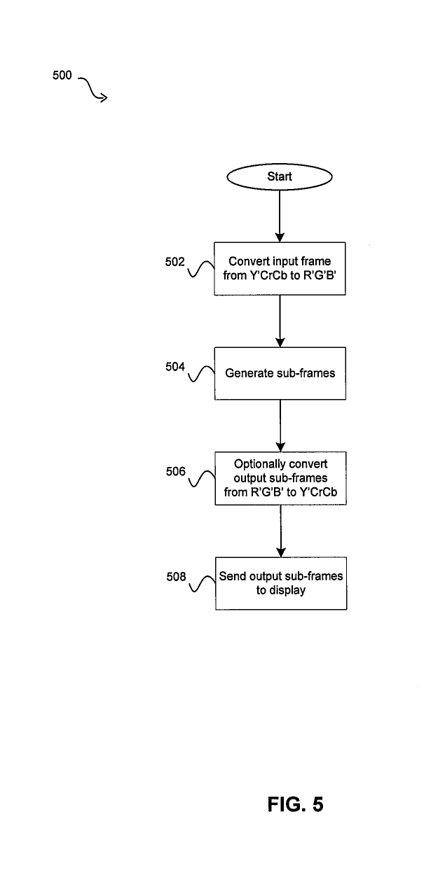

FIG. 5 is an exemplary flow diagram illustrating video motion blur reduction in system that converts f Hz frames to 2f Hz sub-frames, in accordance with an embodiment of the invention. Referring to FIG. 5, there is shown flow 500, representing a process of sequence of exemplary steps that may be performed during motion blur reduction in video processing system. The process may start when a video frame is received in the processing system 300. In step 502, the input frame may be converted from Y′CrCb to R′G′B′. Y′CrCb encoding may be utilized in digital video broadcast. However, while Y′CrCb may provide luminance encoding information for the input frame, encoding luminance information in sub-frames that may be generated in accordance with embodiments of the invention may not be enabled while utilizing Y′CrCb, substantially as described in FIG. 2A. Consequently, R′G′B′ encoding may be utilized to enable performing luminance conversion while preserving color information encoded in the input frame. Also, displays which exhibit motion blur such as LCDs typically require inputs to be in the RGB colorspace. In step 504, the output sub-frame may be generated in the system 300. Generation of output sub-frames may be performed by utilizing calculation formula as set forth in FIG. 2A, FIG. 2B, and FIG. 2C. Alternatively, R′G′B′ encoding information for output sub-frames may simply be read from LUTs that may be utilized in the MBR processor 316, substantially as described in FIG. 3 and FIG. 4A. In step 506, the output sub-frames optionally may be converted from R′G′B′ to Y′CrCb, or alternate colorspace, for compatibility with the recipient of the sub frames data, for example video display 306, which may be utilized to display the output sub-frames. In step 508, the Y′CrCb or RGB (or alternative) encoded output sub-frame may be sent to the video display to be displayed.

Various embodiments of the invention may comprise a method and system for video motion blur reduction. Sample-and-hold displays may be utilized to display video frames. Motion blur may occur in sample-and-hold displays. To reduce motion blur, input frame may be divided into plurality of sub-frames wherein the plurality of sub-frame may preserve, in their totality, the luminance and color of the original input frames. Motion blur reduction may be performed via processing system 300, wherein the MBR processing block 316 may be utilized to perform frame and/or luminance conversion operations. The input frame may initially be Y′CrCb encoded. Consequently, the processing system 300 may convert the input frame from Y′CrCb to R′G′B′ to enable luminance conversion onto the plurality of sub-frame while preserving the coloring information of said input frame. The MBR processing block 316 may compensate for nonlinearity in sample-and-hold displays that may be utilized to display the output sub-frames, wherein said nonlinearity may be caused by the gamma characteristics of said displays. MBR processing block 316 may dynamically perform necessary luminance conversion calculation to determine luminance encoding of said plurality of sub-frames. Alternatively, the MBR block 316 may utilize look-up tables (LUTs) 402, 404, 406, 408, 410, and 412, to set luminance encoding of different color components of each of said plurality of sub-frames based on luminance encoding of the input frames. The LUTs may be programmable to enable modifying and/or updating the video processing system 300.

Another embodiment of the invention may provide a machine-readable storage, having stored thereon, a computer program having at least one code section executable by a machine, thereby causing the machine to perform the steps as described herein for video motion blur reduction.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for video processing, the method comprising:
representing, in a display that utilizes sample-and-hold, an original video frame as a plurality of video sub-frames wherein a duration of said original video frame is equal to a cumulative duration of said plurality of video sub-frames; and
preserving a luminance and a chrominance of said original video frame via a sum effect of said plurality of video sub-frames.

2. The method according to claim 1, wherein said original video frame is extracted from an input video stream, and said plurality of video sub-frames is fed into an output video stream having a frequency that is higher than a frequency of said input video stream.

3. The method according to claim 2, wherein said frequency of said input video stream is f Hz and said frequency of said output video stream is 2f Hz.

4. The method according to claim 3, wherein said frequency of said input video stream is 60 Hz and said frequency of said output video stream is 120 Hz.

5. The method according to claim 1, comprising dividing an energy of said original video frame among said plurality of video sub-frames, wherein a sub-frame of said plurality of video sub-frames comprises most of said energy of original video frame.

6. The method according to claim 1, comprising utilizing a coloring scheme that enables processing of separate color components within said original video frame and/or plurality of video sub-frames.

7. The method according to claim 6, wherein said coloring scheme is RGB.

8. The method according to claim 1, wherein said original video frame is extracted from an input video stream that is encoded utilizing a video encoding scheme.

9. The method according to claim 8, wherein said video encoding scheme comprises Y′CrCb.

10. The method according to claim 1, wherein said display that utilizes sample-and-hold comprises a Liquid Crystal Display (LCD), and/or a similar display.

11. The method according to claim 1, comprising utilizing one or more look-up-tables (LUT) to generate said plurality of video sub-frames.

12. The method according to claim 11, wherein said one or more look-up-tables (LUT) are programmable.

13. The method according to claim 1, comprising compensating for a non-linearity caused by utilizing gamma compression to encode a linear luminance in said original video frame and/or said plurality of video sub-frames.

14. The method according to claim 13, wherein a first sub-frame in said plurality of video sub-frames comprises a linear luminance that produces a resultant normalized luminance intensity, wherein:
said resultant normalized luminance intensity of said first sub-frame is equivalent to twice a normalized luminance intensity of said original video frame minus a normalized luminance intensity of linear luminance 0 in said display; and
said resultant normalized luminance intensity of said first sub-frame does not exceed a maximum normalized luminance intensity in said display.

15. The method according to claim 14, wherein a second sub-frame in said plurality of video sub-frames comprises a non-linear luminance, after said first frame reaches said maximum normalized luminance intensity in said display, that produces a resultant normalized luminance intensity, wherein said resultant normalized luminance intensity of said second sub-frame is equivalent to twice said normalized luminance intensity of said original video frame minus said maximum normalized luminance intensity in said display.

16. A system for video processing, the system comprising:
one or more processors that enable representation, in a display that utilizes sample-and-hold, of an original video frame as a plurality of video sub-frames wherein a duration of said original video frame is equal to a cumulative duration of said plurality of video sub-frames; and
said one or more processors enable preservation of a luminance and a chrominance of said original video frame via a sum effect of said plurality of video sub-frames.

17. The system according to claim 16, wherein said original video frame is extracted from an input video stream, and said plurality of video sub-frames is fed into an output video stream having a frequency that is higher than a frequency of said input video stream

18. The system according to claim 17, wherein said frequency of said input video stream is f Hz and said frequency of said output video stream is 2f Hz.

19. The system according to claim 18, wherein said frequency of said input video stream is 60 Hz and said frequency of said output video stream is 120 Hz.

20. The system according to claim 16, wherein said one or more processors enable division of an energy of said original video frame among said plurality of video sub-frames, wherein a sub-frame of said plurality of video sub-frames comprises most of said energy of original video frame.

21. The system according to claim 16, wherein said one or more processors enable utilization of a coloring scheme that enables processing of separate color components within said original video frame and/or plurality of video sub-frames.

22. The system according to claim 21, wherein said coloring scheme is RGB.

23. The system according to claim 16, wherein said original video frame is extracted from an input video stream that is encoded utilizing a video encoding scheme.

24. The system according to claim 23, wherein said video encoding scheme comprises Y′CrCb.

25. The system according to claim 16, wherein said display that utilizes sample-and-hold comprises a Liquid Crystal Display (LCD), and/or a similar display.

26. The system according to claim 16, wherein said one or more processors enable utilization of one or more look-up-tables (LUT) to generate said plurality of video sub-frames.

27. The system according to claim 26, wherein said one or more look-up-tables (LUT) are programmable.

28. The system according to claim 16, wherein said one or more processors enable compensation for non-linearity caused by the display's non-linear response characteristics and/or by utilizing gamma compression to encode linear luminance in said original video frame and/or said plurality of video sub-frames.

29. The system according to claim 28, wherein a first sub-frame in said plurality of video sub-frames comprises a linear luminance that produces a resultant normalized luminance intensity, wherein:
said resultant normalized luminance intensity of said first sub-frame is equivalent to twice a normalized luminance intensity of said original video frame minus a normalized luminance intensity of linear luminance 0 in said display; and
said resultant normalized luminance intensity of said first sub-frame does not exceed a maximum normalized luminance intensity in said display.

30. The system according to claim 29, wherein a second sub-frame in said plurality of video sub-frames comprises a non-linear luminance, after said first frame reaches said maximum normalized luminance intensity in said display, that produces a resultant normalized luminance intensity, wherein said resultant normalized luminance intensity of said second sub-frame is equivalent to twice said normalized luminance intensity of said original video frame minus said maximum normalized luminance intensity in said display.
